(19) United States
(12) Patent Application Publication
(10) Pub. No.: US 2008/0282442 A1
(43) Pub. Date: Nov. 20, 2008

(54) GARMENT PROVIDED WITH A HARNESS

(75) Inventor: Anne Bauvois, Hurtieres (FR)

Correspondence Address: CANTOR COLBURN, LLP, 20 Church Street, 22nd Floor, Hartford, CT, 06103, US

(73) Assignee: TYAX, Moirans (FR)

(21) Appl. No.: 12/121,052

(22) Filed: May 15, 2008

(30) Foreign Application Priority Data
May 16, 2007 (FR) 0755123

(51) Int. Cl. A41D 1/06; A62B 35/00

(52) U.S. Cl. 2/79; 2/227; 182/3

(57) ABSTRACT

In a garment provided with a harness (2) comprising a belt (10), an elastically stretchable element (19) is incorporated so as to allow a movement of the harness (2) with regard to at least one portion of the garment (1) in case of traction (T) on the harness (2), while correctly positioning the harness (2) and at least this portion of the garment (1) with regard to one another in the absence of such traction (T).

### TECHNICAL FIELD

The present invention relates to the field of individual safety equipment, such as apparatus intended to arrest a fall. More precisely, it relates to a garment provided with a harness.

### PRIOR ART

Some sports activities, such as activities in the mountains, incur a real risk of falling or of an accident that is liable to lead the first aid units to call on winching or heliwinching techniques. The same applies to certain operations carried out by firefighters or by other professionals exercising a risky profession. When one knows in advance that a harness will be useful for a winching operation, one takes one along, but an accident is always an unforeseen event. Similarly, in the mountains, one could face a problem on a steep slope where the risk of falling is high, but where one had not initially intended to come. In such circumstances, one often lacks a harness, because a harness has the drawback of being cumbersome since it represents an added accessory.

To remedy this problem, it has already been considered to incorporate a harness in a garment. For example, each of the documents CA-2 404 214 and U.S. Pat. No. 5,136,724 proposes a fireman's trousers in which a harness is mounted. However, it should be observed that it is difficult to reconcile the specificities of a garment and the search for sartorial qualities with the demands that a harness must satisfy in terms of safety of use. In particular, a garment must be comfortable and as easy as possible to don as to remove. Furthermore, a harness must be designed taking account of the dynamic behavior of a body sustaining an impact via this harness. Moreover, special attention must be paid to the correct positioning of the harness on the user's body.

In case of upward traction on a harness incorporated in trousers as has been proposed for the time being, the trousers are dragged by the harness against the user's crutch. The crutch is thus squeezed and may be bruised thereby. Similarly, the trouser seams are subject to forces that are liable to undo them.

It appears from the above that the incorporation of a harness in a garment comprises specific risks. For all that, this incorporation must hinder the smooth operation of the harness as little as possible.

Document DE-87 14 979 U describes a watertight rescue trousers incorporating a harness. This harness passes through keepers which couple it to the rescue trousers and which are elastic for an undetermined reason. If the harness escapes from one or more of these keepers, the combination can become dangerously unbalanced.

It is at least one object of the invention to improve the operation of a harness incorporated in a garment.

### SUMMARY OF THE INVENTION

According to the invention, this object is achieved thanks to a garment provided with a harness comprising a belt. At least one elastically stretchable element is incorporated in this garment so as to allow a movement of the harness with regard to at least one portion of the garment in case of traction on the harness, while correctly positioning the harness and at least this portion of the garment with regard to one another in the absence of such traction.

At least part of the garment and the harness can move with regard to one another to some extent, and are therefore somewhat disengaged in case of traction on the harness. Accordingly, such traction is transmitted to the user's body essentially via the harness, and little, if at all, via the garment, which neither squeezes certain parts of the user's body, nor is subject to stresses liable to tear it.

Moreover, the movement of the harness and, more generally, its operation, are not hindered by the garment.

The elastically stretchable element may be one of the textile pieces stitched together or otherwise assembled to form the actual garment, that is one of the textile pieces constituting the garment, in which case it can be made from a fabric commonly called “stretch”.

However, it may be advantageous for this not to be the case, particularly in terms of satisfactory operation of the harness in case of falling. In particular, said elastically stretchable element may be an elastically stretchable connector which joins the harness to the garment so as to allow a movement of the harness with regard to the garment in case of traction on the harness, while correctly positioning the harness and at least this portion of the garment with regard to one another in the absence of such traction.

Advantageously, the garment comprises a left leg, a right leg and a waistband prolonged downward to these left and right legs. It can therefore consist in particular of trousers, shorts or overalls.

Preferably, the elastically stretchable element joins the belt of the harness to the waistband of the garment.

When this is the case, the elastically stretchable element joins the back of the waistband of the garment to the back of the belt of the harness, which is an advantage.

In the normal use position, the back of the belt of the harness is offset upward with regard to the waistband of the garment. In this way, the belt of the harness can be correctly positioned around the user's hips, without affecting the comfort and esthetics of the garment.

Advantageously, the elastically stretchable element comprises a skirt which is made from an elastically stretchable textile product and which comprises a lower portion, an upper portion, and an intermediate portion connecting these lower and upper portions to one another, one of said lower and upper portions and the other portion among these lower and upper portions being joined respectively to the waistband of the garment and to the belt of the harness. Such a skirt behaves like a piece of clothing and is therefore perfectly incorporated in the garment as though it were an integral part thereof. In particular, it is designed to cover the small of the user's back, and can therefore protect it from the weather in addition to performing its primary function.

The harness may be selected from several different types of harness. For example, it may be selected from opening belt harnesses. The belt of such a harness can be provided with a front buckle or other equivalent means for its closure, or even its length adjustment.

The front portion of the belt of the harness can also consist of two brackets, of which a roping hook is designed to join the respective ends in the form of a loop, in order to close the belt, while enabling the fastening of a rope. However, such a hook may be badly installed, particularly if the user is not experienced in the use of a harness. In other words, the use of a harness whose belt is designed to be closed by a roping hook incurs a risk.

Thus, preferably, a front portion of the belt of the harness forms a lanyard, at least one portion of this lanyard being straightenable from a bent configuration to a horizontally deployed configuration in which the belt of the harness bounds a larger passage than when at least said portion of the lanyard is in its bent configuration. When the lanyard is in its deployed configuration, the belt of the harness can easily cross the hips of a user and the garment can be easily donned. When the lanyard is in its bent configuration or configuration of adjustment to the user's waist, the belt of the harness is kept correctly positioned on this user.

The lanyard may comprise two ends stitched to another element constituting the belt, as in the example described below. It may also have the form of a buckle which connects two transversally offset portions of the harness and which can bring together these two portions when an upward traction is exerted on an upper segment of this buckle, in order to make the latter narrower by lengthening it upward.

Advantageously, the garment comprises a front opening and a device for closing this opening, where the waistband of the garment is interrupted, and whose closure brings at least said portion of the lanyard into its bent configuration. In other words, the belt of the harness can be adjusted to the user simply by closing the front opening of the garment.

Preferably, the harness comprises a strong left loop for the passage of a leg of the user, a strong right loop for the passage of the other leg of the user, a flexible and strong left strap connecting the left loop to the belt of the harness and a flexible and strong right strap connecting the right loop to the belt of the harness.

When this is the case, the garment may comprise a right guide for the right strap and a left guide for the left strap, these left and right guides being placed on either side of said opening so as to bring at least said portion of the lanyard into its bent configuration during a closure of said opening and being brought together by this closure. The fact that the closure of the opening brings the lanyard into its bent configuration may result from the presence and the particular arrangement of left and right guides, which have the further advantage of not preventing a movement of the harness with regard to the garment.

Preferably, the garment comprises two elastically stretchable connectors, that is a left stretchable connector, which connects the left loop of the harness to the left leg of the garment, and a right stretchable connector, which connects the right loop of the harness to the right leg of the garment. Thanks to this, the left and right loops of the harness can be secured in the legs of the garment, that is in their correct positions.

Advantageously, the left stretchable connector comprises a keeper through which the left loop of the harness passes, the right stretchable connector comprising a keeper through which the right loop of the harness passes.

Preferably, the garment comprises an outer textile layer and an inner lining, between which the left and right loops of the harness are located. In this way, the loops of the harness are masked. They cannot irritate the user who, in addition, incurs no risk of hooking thereto when he dons or removes the garment.

Preferably, said left guide comprises the edge of a slit via which said left strap passes through said lining, said right guide comprising the edge of a slit via which said right strap passes through said lining. This design has the advantage of being particularly simple, economical and compact.

The garment may in particular be or at least comprise a ski trousers.

### BRIEF DESCRIPTION OF THE FIGURES

The invention will be better understood from a reading of the description that follows, provided exclusively as an example and with reference to the appended drawings, in which:

FIG. 1 is a schematic, perspective and cutaway view of the upper portion of a ski trousers according to the invention;

FIG. 2 is a schematic perspective view of the upper portion of the trousers in FIG. 1;

FIG. 3 is a perspective view of a harness fitted to the trousers in FIGS. 1 and 2;

FIG. 4 is a schematic partial cross section along IV-IV in FIG. 1; and

FIG. 5 is a schematic elevation view of a ski dungarees according to the invention.

### POSSIBLE EMBODIMENTS OF THE INVENTION

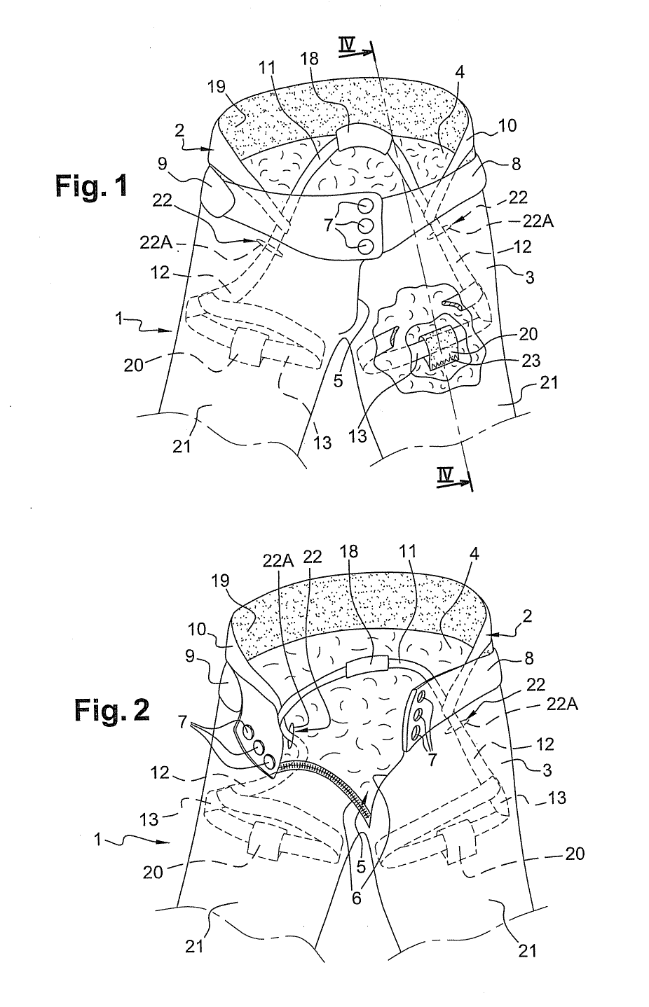

FIG. 1 shows the upper portion of a ski trousers 1, incorporating a shoulder belt or roping harness 2. The trousers 1 comprise a plurality of successive layers, that is an outer textile 3 and a lining 4. Between this textile 3 and this lining 4, one or more other layers may be provided, of which one may perform a thermal insulation function.

Thus as shown in FIG. 2, an opening or fly 5 is provided on the front of the trousers 1, from the upper edge of which it extends downward, toward the crutch. The means for closing this fly 5 comprise a zip fastener 6, and a row of three press studs 7 placed at the waistband 8 of the trousers 1.

The waist size of the trousers 1, that is the circumference of the trousers 1 at its waist 8, can be modified and adjusted to the morphology of a user, thanks to length adjustment means having the form of a half-back belt 9, which is known per se, which can be adjusted to different lengths and which is provided for the purpose with joining means of the “loop and hook” type, frequently designated by the term Velcro® and not shown in the drawings.

The harness 2 is shown alone in FIG. 3. It comprises a closed and non-opening belt 10, which comprises back and side portions formed by a band 15 and a front portion formed by a curved lanyard 11 for fastening an outer strap not shown. Each end of the lanyard 11 is prolonged downward by a flexible and strong strap 12 which connects the belt 10 to one of two strong left and right loops 13, each for the passage of a leg of the user.

In the example shown, one and the same band 14 forms the two loops 13, the straps 12 and the lanyard 11. Each of the ends of the band 15 is joined by a stitch 16 to the band 14, between the lanyard 11 and one of the straps 12. At least one of the bands 14 and 15 may comprise a central strip provided with two longitudinal reinforcement pipings made from a textile product such as an openwork fabric commonly called “mesh fabric”.

Each loop 13 is kept in shape by a stitch 17 which subjects one end of the band 14 to another part of this band 14. A sheath 18 threaded on the upper portion of the lanyard 11 can protect this upper portion from abrasion by friction on the ropes or the hooks.

In the example shown, the harness 2 is stationary. As FIG. 1 shows, it is joined to the ski trousers 1 by three elastically stretchable elements, that is a back skirt 19 and two keepers 20, each of which retains a loop 13 of the harness 2 at the level of a leg 21 of the trousers 1. Conversely to the belt 10, each loop 13, in the example shown, extends between the outer textile 13 and the lining 4 which it surrounds.

Two slits 22 are cut in the lining 4 and placed on either side of the fly 5. Through each of them passes a strap 12 which thus crosses the lining 4. Each strap 12 can slide along a non-horizontal direction, into a slit 22 where it is guided. The length of the straps 12 is selected so that each end of the lanyard 11 is at or at least close to a slit 22, that is in the neighborhood of a predefined position with regard to the waistband 8 and the fly 5, on one side thereof, when the trousers 1 are donned. In other words, by forming a guide for a strap 12, each edge 22A of a slit 22 participates in securing one end of the lanyard 11 in the neighborhood of this predefined position.

Each keeper 20 comprises a strip that forms a loop and whereof the two ends folded against one another are subjected by a stitch 23 to a leg 21 of the trousers 1 and, more precisely, to the outer textile 3 of the trousers 1.

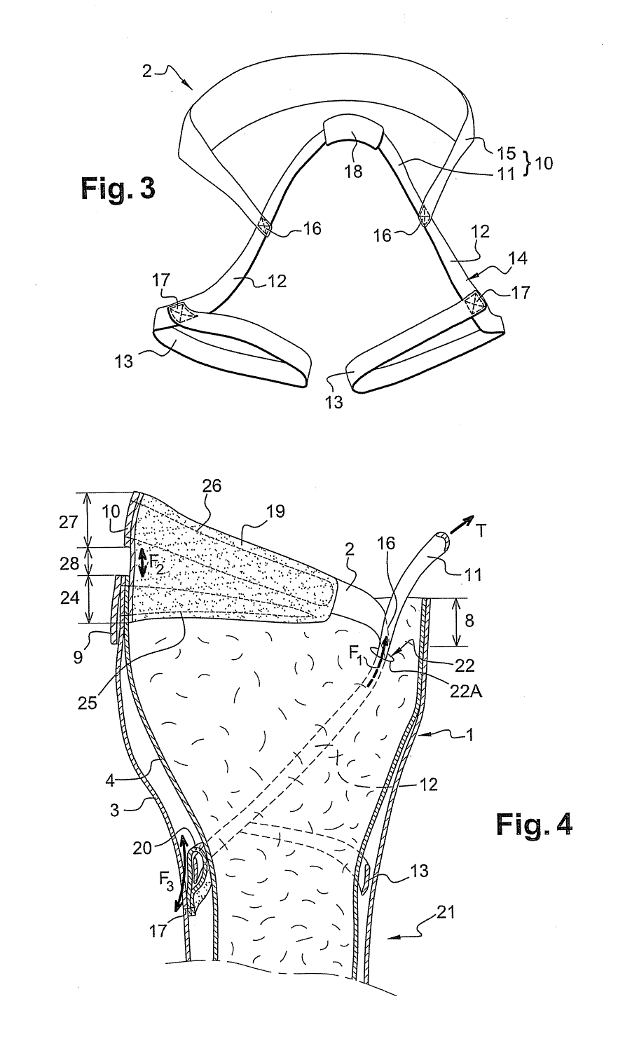

The lanyard 11 extends upward toward the top of the waistband 8 of the trousers 1. The same applies to the back portion of the belt 10. As shown in FIG. 4, this back portion is higher than the upper edge of the trousers 1, to which it is connected by the skirt 19. This skirt 19 is designed to cover the small of the user's back and stops before reaching the front of the trousers 1. It comprises a lower portion 24 joined by a stitch 25 to the waistband 8 of the trousers 1. Another stitch 26 joins a back and outer portion of the belt 10 to an upper portion 27 of the skirt 19, whereof an intermediate portion 28 connects the lower portion 24 with this upper portion 27.

The skirt 19 and the keepers 20 can be made from the same elastically stretchable material, in particular textile, such as Lycra®, which is the case in the example shown.

When the fly 5 is open and the edges thereof are separated from one another, that is as shown in FIG. 2, it is easy to don the trousers 1 insofar as the lanyard 11 is deployed, which is reflected by an enlargement of the passage bounded by the belt 10. Once a user has donned the trousers 1, he closes the fly 5, during which the edges 22A of the slits 22 drag along the straps 12 toward one another, and in doing so, place the ends of the lanyard 11 at a predefined distance from one another, so that this lanyard 11 is bent. After this, the passage bounded by the belt 10 is narrowed and the back portion of the belt 10 is kept correctly positioned on the user's hips.

In case of upward traction T on the lanyard 11, for example due to a fall, each strap 12 slides into one of the slits 22, symbolized by the arrow F₁ in FIG. 4. Simultaneously, the keepers 10 and the intermediate portion 28 of the skirt 19 are stretched vertically, in the direction of the double arrows F₂ and F₃, in order to allow a relative overall upward movement of the harness 2 with regard to the trousers 1. This relative movement with regard to the trousers 1 substantially improves the operation of the harness 2, whereof the movement is not hindered by the trousers 1.

Furthermore, the trousers 1 does not follow the harness 2 during the traction T, thanks to which it does not squeeze certain parts of the user's body, in particular the user's crutch, while its stitches are not excessively stressed, to the point of giving way.

The harness 2 is set to the right size for a given user when this user has correctly selected the trousers 1 for his waist. This constitutes an advantage of the fact that the harness 2 is incorporated in the trousers 1.

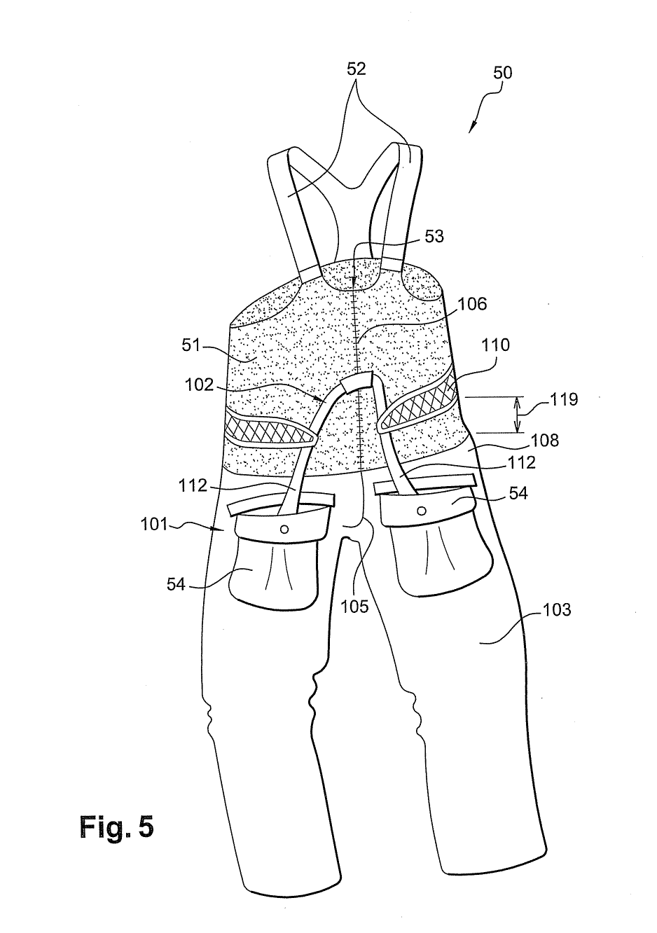

FIG. 5 shows a ski dungarees 50 provided with a roping harness 102 identical to that of the trousers 1. In the following account, this dungarees 50 is only described insofar as it is different from the trousers 1. Furthermore, a reference used below to denote a part of the dungarees 50 similar or equivalent to a reference part of the trousers 1 is constructed by adding 100 to the reference identifying this part in the trousers 1.

In addition to the trousers 101, the dungarees 50 comprises a tubular top 51 or flap for protecting at least the lower part of the torso of a user, as well as two suspenders 52. The top 51 is provided with suspenders 52 and prolongs the trousers 101 upward, to the waistband 108 of which it is joined.

A lower portion of the top 51 forms the elastically stretchable skirt 119. For this purpose, this top 51 is made from an elastically stretchable textile, such as Lycra (registered trade mark), to which the belt 110 of the harness 102 is joined. While being a component of the actual garment, the top 51 performs a disengaging function similar to that of the skirt 19 during a traction T on the shoulder strap.

A front slit 53, provided in the top 51, prolongs the fly 105. It is provided with the same zip fastener 106 as this fly 105.

The straps 112 of the harness 102 emerge on the front of the trousers 101, passing through the outer textile 103, via outer pockets 54 of the trousers 101 and not by passing through the lining of these trousers 101.

The invention is not limited to the embodiments described above. In particular, the back skirt 19 or 119 may be discontinuous along the waistband of the trousers 1. It may further be replaced and/or supplemented by one or more successive keepers which are joined to the waistband of the trousers and via which the belt of the harness passes.

Moreover, although the one described above is a leggings harness, the harness may also be a complete harness, that is combining a leggings harness and an adjacent torso portion, in which case the garment can advantageously be an overalls. The harness may also consist of a torso portion and can then be incorporated in a jacket.

Furthermore, the lanyard 11 may have the form of a loop joining the straps 12 by passing freely around these straps 12. When an upward traction T is applied locally thereto, between the two straps 12, this loop is vertically elongated while narrowing horizontally, thereby drawing the two straps 12 toward one another.

Similarly, the invention is not limited to ski trousers or ski dungarees. On the contrary, it can be incorporated in other types of garment, for example in mountaineering shorts, a seaman's oilskins, a neoprene surfboard suit, various protective garments for professionals servicing ski lifts in ski resorts or garments for certain specialized units of the police or the army.

Moreover, the loops 13 may be connected to the lining 4 and not to the outer textile 3. Furthermore, the keepers 20 may be lengthened to the point of being virtually annular, particularly in the case in which the garment has no lining.

1. A garment provided with a harness (2; 102) comprising a belt (10; 110), characterized in that at least one elastically stretchable element (19, 20; 119) is incorporated in this garment so as to allow a movement of the harness (2; 102) with regard to at least one portion of the garment (1; 50) in case of traction (T) on the harness (2; 102), while correctly positioning the harness (2; 102) and at least this portion of the garment (1; 50) with regard to one another in the absence of such traction (T).

2. The garment as claimed in claim 1, characterized in that said elastically stretchable element is an elastically stretchable link (19, 20) which joins the harness (2; 102) to the garment (1; 50) so as to allow a movement of the harness (2; 102) with regard to the garment (1; 50) in case of traction (T) on the harness (2; 102), while correctly positioning the harness (2; 102) and the garment (1; 50) with regard to one another in the absence of such traction (T).

3. The garment as claimed in either of the preceding claims, characterized in that it comprises a left leg (21), a right leg (21) and a waistband (8; 108) prolonged downward to these left and right legs (21).

4. The garment as claimed in claim 3, characterized in that the elastically stretchable element (19; 119) joins the belt (10; 110) of the harness (2; 102) to the waistband (8; 108) of the garment (1; 50).

5. The garment as claimed in claim 4, characterized in that the elastically stretchable element (19; 119) joins the back of the waistband (8; 108) of the garment (1; 50) to the back of the belt (10; 110) of the harness (2; 102).

6. The garment as claimed in either of claims 4 and 5, characterized in that, in the normal use position, the back of the belt (10; 110) of the harness (2; 102) is offset upward with regard to the waistband (8; 108) of the garment (1; 50).

7. The garment as claimed in any one of claims 4 to 6, characterized in that the elastically stretchable element comprises a skirt (19; 119) which is made from an elastically stretchable textile product and which comprises a lower portion (24), an upper portion (27), and an intermediate portion (28) connecting these lower and upper portions (24, 27) to one another, one of said lower and upper portions (24, 27) and the other portion among these lower and upper portions (24, 27) being joined respectively to the waistband (8; 108) of the garment (1; 50) and to the belt (10; 110) of the harness (2; 102).

8. The garment as claimed in claim 7, characterized in that said skirt is a lower portion (119) of a top of overalls or dungarees (51) which constitutes the garment (50) and which extends upward from the waistband (108) of this garment (50).

9. The garment as claimed in any one of claims 4 to 8, characterized in that a front portion of the belt (10; 110) of the harness (2; 102) forms a lanyard (11), at least one portion of this lanyard (11) being straightenable from a bent configuration (FIG. 1) to a deployed configuration (FIG. 2) in which the belt (10; 110) of the harness (2; 102) bounds a larger passage than when at least said portion of the lanyard (11) is in its bent configuration.

10. The garment as claimed in claim 9, characterized in that it comprises a front opening (5; 105, 53) and a device (6, 7; 106) for closing this opening (5; 105, 53), where the waistband (8; 108) of the garment (1; 50) is interrupted, and whose closure brings at least said portion of the lanyard (11) into its bent configuration.

11. The garment as claimed in any one of claims 4 to 10, characterized in that the harness (2; 102) comprises a strong left loop (13) for the passage of a leg of the user, a strong right loop (13) for the passage of the other leg of the user, a flexible and strong left strap (12; 112) connecting the left loop (13) to the belt (10; 110) of the harness (2; 102) and a flexible and strong right strap (12; 112) connecting the right loop (13) to the belt (10; 110) of the harness (2; 102).

12. The garment as claimed in claims 10 and 11, characterized in that it comprises a right guide (22) for the right strap (12) and a left guide (22) for the left strap (12), these left and right guides (22) being placed on either side of said opening (5) so as to bring at least said portion of the lanyard (11) into its bent configuration during a closure of said opening (5) and being brought together by this closure.

13. The garment as claimed in either of claims 11 and 12, characterized in that it comprises two elastically stretchable connectors, that is a left stretchable connector (20), which connects the left loop (13) of the harness (2; 102) to the left leg (21) of the garment (1; 50), and a right stretchable connector (20), which connects the right loop (13) of the harness (2; 102) to the right leg (21) of the garment (1; 50).

14. The garment as claimed in claim 13, characterized in that the left stretchable connector comprises a keeper (20) through which the left loop (13) of the harness (2; 102) passes, the right stretchable connector comprising a keeper (20) through which the right loop (13) of the harness (2; 102) passes.

15. The garment as claimed in any one of claims 11 to 14, characterized in that it comprises an outer textile layer (3; 103) and an inner lining (4), between which the left and right loops (13) of the harness (2; 102) are located.

16. The garment as claimed in claims 12 and 15, characterized in that said left guide comprises the edge (22A) of a slit (22) via which said left strap (12) passes through said lining (4), said right guide comprising the edge (22A) of a slit (22) via which said right strap (12) passes through said lining (4).
